(19) United States
(12) Patent Application Publication
(10) Pub. No.: US 2020/0323074 A1
(43) Pub. Date: Oct. 8, 2020

(54) SWITCH CIRCUIT FOR IOT DEVICE

(71) Applicant: XIAMEN ECO LIGHTING CO. LTD., Xiamen (CN)

(72) Inventor: YANFENG HUANG, Xiamen (CN)

(21) Appl. No.: 16/843,865

(22) Filed: Apr. 8, 2020

Related U.S. Application Data
(60) Provisional application No. 62/830,665, filed on Apr. 8, 2019.

(51) Int. Cl. H05B 47/19; H05B 45/12; H04R 3/00

(52) U.S. Cl. CPC H05B 47/19; H04R 3/00; H05B 45/12

(57) ABSTRACT

A switch circuit is provided for controlling an IoT device like a lighting device with a wireless module. The switch circuit uses a voltage detector, instead of a current sensing module, for detecting to determine whether to perform corresponding switch operation.

### RELATED APPLICATION

The present application priority of U.S. provisional application No. 62/830,665.

### FIELD

The present application is related to a switch circuit and more particularly related to a switch circuit for IoT devices.

### BACKGROUND

IoT (Internet of Things) are widely developing these years. Lights, speakers, detectors, door gates, security devices, and various devices with network connectivity are designed to interact for providing a smart environment making people life more convenient.

The Internet of things (IoT) is a system of interrelated computing devices, mechanical and digital machines provided with unique identifiers (UIDs) and the ability to transfer data over a network without requiring human-to-human or human-to-computer interaction.

The definition of the Internet of things has evolved due to the convergence of multiple technologies, real-time analytics, machine learning, commodity sensors, and embedded systems. Traditional fields of embedded systems, wireless sensor networks, control systems, automation (including home and building automation), and others all contribute to enabling the Internet of things. In the consumer market, IoT technology is most synonymous with products pertaining to the concept of the “smart home”, covering devices and appliances (such as lighting fixtures, thermostats, home security systems and cameras, and other home appliances) that support one or more common ecosystems, and can be controlled via devices associated with that ecosystem, such as smartphones and smart speakers.

The control circuits used in IoT devices are important because they involve cost, reliability and convenience which may affect people adopting such devices. There are various design goals on such control circuits. Some may operate with large sensitivity while others may particularly consider electricity consumption.

There are a number of serious concerns about dangers in the growth of IoT, especially in the areas of privacy and security, and consequently industry and governmental moves to address these concerns have begun.

It is important and beneficial to figure out a feasible solution that is acceptable for people to create real values. In other words, even with configuration or recognition of problems brings great value to this field.

### SUMMARY

In some embodiments, an IoT apparatus includes an electric load, a remote switch, a line terminal, a neutral terminal, a load terminal, a traveler terminal, a conductive control system, a wireless module, a voltage detector and a switch circuit.

The electric load may be a light source, a speaker, a sensor, a robot or any IoT (Internet of Things) device.

The remote switch has a first remote terminal, a second remote terminal and a common terminal. The common terminal is connected to the electric load. The remote switch has a first position in which the common terminal is electrically connected to the first remote terminal and has a second position in which the common terminal is electrically connected to the second remote terminal.

The line terminal is electrically connected to an AC hot line. The neutral terminal is electrically connected to an AC neutral line. The load terminal is selectively connecting to the first remote terminal of the remote switch.

The traveler terminal is selectively connecting to the second remote terminal of the remote switch.

The conductive control system includes a relay switching circuit. The conductive control system has two control states as a first control state and a second control state. The line terminal is electrically connected to the load terminal in the first control state. The line terminal is electrically connected to the traveler terminal in the second control state. The relay switching circuit is switchable between the two control states. The relay switching circuit electrically connects the line terminal to the load terminal and electrically disconnects the line terminal from the traveler terminal in the first control state. The relay switching circuit electrically connects the line terminal to the traveler terminal and electrically disconnects the line terminal from the load terminal in the second control state.

The wireless module receives a control command, e.g. from a home media server or a mobile phone. Users may send the control command manually. The control command may also be generated automatically under a predetermined condition or schedule.

The voltage detector is connected to the line terminal and the neutral terminal for detecting a voltage instead of a loading current.

The switch circuit is used for controlling the conductive control system to switch between the first control state and the second control state. The switch circuit is operable in response to the control command of the wireless module and the detected voltage of the voltage detector.

In some embodiments, the remote switch is a three-way switch.

In some embodiments, the relay switching circuit is an electromagnetic relay switch.

In some embodiments, the switch circuit controls the conductive control system to switch between the first control sate and the second control state even if there is no load current flowing.

In some embodiments, the electric load is a LED module.

In some embodiments, the electric load is controlled by the conductive control system to change a luminance level.

In some embodiments, the LED module has multiple types of LED chips and the conductive control system controls the LED chips to emit a mixed color.

In some embodiments, the LED module has multiple types of LED chips and the conductive control system controls the LED chips to emit a mixed color temperature.

In some embodiments, the IoT apparatus may also include a wall switch control detector electrically connected to a wall switch for receiving a wall switch operation, the wall switch operation being translated by the wall switch control detector for combining the wall switch operation with the control command of the wireless module.

In some embodiments, the IoT apparatus may also include a power supply circuit connected to the line terminal and the neutral terminal for converting an alternating current to a direct current supplying to the wireless module and the switch circuit.

In some embodiments, the switch circuit further receives an identification authentication message for determining as a reference when determining switching between the first control state and the second control state.

In some embodiments, the wireless module and the switch circuit are detachable from the IoT apparatus.

In some embodiments, where a battery supplies power to the wireless module and the switch circuit when there is no power between the line terminal and the neural terminal.

In some embodiments, the electric load is a speaker.

In some embodiments, the speaker generates different sound in the first control state and the second state.

In some embodiments, the IoT apparatus may also include a detector for detecting a light status of a neighboring light device, the switch circuit controls the conductive control system by reference to the detected light status.

In some embodiments, the switch controls the conductive control system to turn on the electric load when the detected light status indicates that the light device is turned off on at a first moment and to turn off the electric load when the detected light status indicates that the light device is turned on at a second moment.

In some embodiments, the control switch controls the conductive switch system to generate a light compensating another light of the neighboring light device to generate a desired color temperature.

### BRIEF DESCRIPTION OF DRAWINGS

FIG. 1 shows an example of an environment for controlling a lighting device.

FIG. 2 shows another example on controlling a lighting device.

FIG. 3 shows another example on controlling a lighting device.

FIG. 4 shows a wireless control architecture example in an embodiment.

FIG. 5 shows another wireless control architecture example in another example.

FIG. 6 shows a circuit diagram example.

FIG. 7 shows a circuit diagram example in an embodiment.

FIG. 8A shows a circuit diagram of an embodiment.

FIG. 8B shows another circuit diagram of an embodiment.

FIG. 9 shows a circuit diagram in an embodiment.

FIG. 10 shows a circuit diagram in an embodiment.

FIG. 11 illustrates a structure of an IoT apparatus embodiment.

FIG. 12 shows a LED module with multiple types of LED chips.

FIG. 13 shows a wall switch operation.

FIG. 14 shows two adjacent light devices with responding functions.

### DETAILED DESCRIPTION

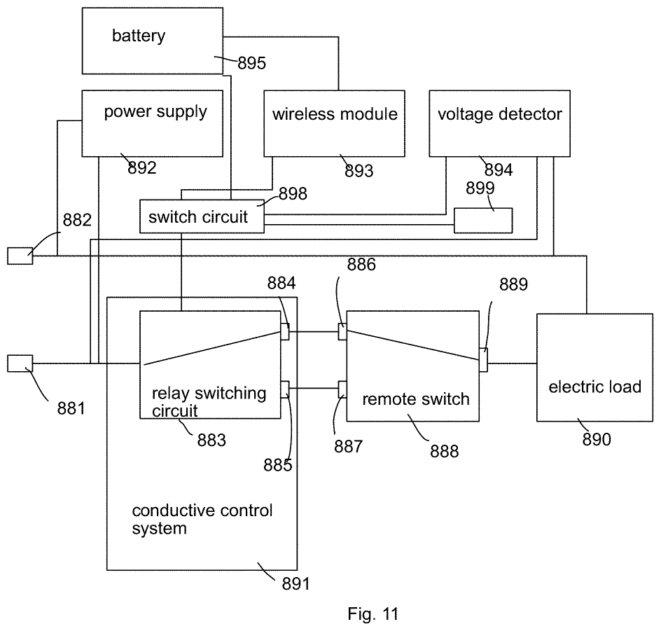

In FIG. 11, an IoT apparatus includes an electric load 890, a remote switch 888, a line terminal 881, a neutral terminal 882, a load terminal 884, a traveler terminal 885, a conductive control system 891, a wireless module 893, a voltage detector 894 and a switch circuit 898.

The electric load 890 may be a light source, a speaker, a sensor, a robot or any IoT (Internet of Things) device.

The remote switch 888 has a first remote terminal 886, a second remote terminal 887 and a common terminal 889. The common terminal 889 is connected to the electric load 890. The remote switch 888 has a first position in which the common terminal 889 is electrically connected to the first remote terminal 886 and has a second position in which the common terminal 889 is electrically connected to the second remote terminal 887.

The line terminal 881 is electrically connected to an AC hot line. The neutral terminal 882 is electrically connected to an AC neutral line.

The conductive control system 891 includes a relay switching circuit 883. The conductive control system 891 has two control states as a first control state and a second control state. The line terminal 881 is electrically connected to the load terminal 884 in the first control state. The line terminal 881 is electrically connected to the traveler terminal 885 in the second control state. The relay switching circuit 883 is switchable between the two control states. The relay switching circuit 883 electrically connects the line terminal 881 to the load terminal 884 and electrically disconnects the line terminal 881 from the traveler terminal 885 in the first control state. The relay switching circuit 883 electrically connects the line terminal 881 to the traveler terminal 885 and electrically disconnects the line terminal 881 from the load terminal 884 in the second control state.

The wireless module 893 receives a control command, e.g. from a home media server or a mobile phone. Users may send the control command manually. The control command may also be generated automatically under a predetermined condition or schedule.

The voltage detector 894 is connected to the line terminal 881 and the neutral terminal 882 for detecting a voltage instead of a loading current.

The switch circuit 898 is used for controlling the conductive control system 891 to switch between the first control state and the second control state. The switch circuit 898 is operable in response to the control command of the wireless module 893 and the detected voltage of the voltage detector 894.

In some embodiments, the remote switch is a three-way switch.

In some embodiments, the relay switching circuit is an electromagnetic relay switch.

In some embodiments, the switch circuit controls the conductive control system to switch between the first control sate and the second control state even if there is no load current flowing.

In some embodiments, the electric load is a LED module.

In some embodiments, the electric load is controlled by the conductive control system to change a luminance level.

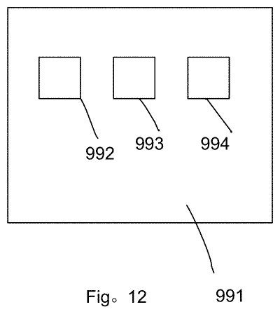

In FIG. 12, the LED module 891 has multiple types of LED chips 891, 892, 893 and the conductive control system controls the LED chips to emit a mixed color.

In some embodiments, the LED module has multiple types of LED chips and the conductive control system controls the LED chips to emit a mixed color temperature.

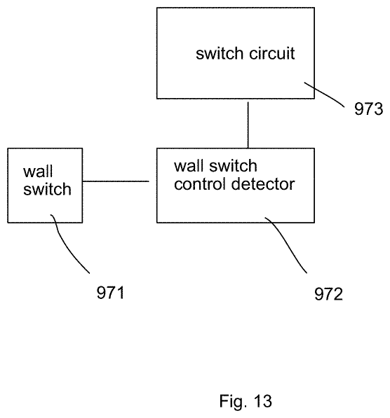

In FIG. 13, the IoT apparatus may also include a wall switch control detector 972 electrically connected to a wall switch 971 for receiving a wall switch operation, the wall switch operation being translated by the wall switch control detector 972 for combining the wall switch operation with the control command of the wireless module for the switch circuit 973 to provide more flexibility and functions.

In FIG. 11, the IoT apparatus may also include a power supply circuit 892 connected to the line terminal 881 and the neutral terminal 882 for converting an alternating current to a direct current supplying to the wireless module 893 and the switch circuit 898.

In FIG. 11, the switch circuit 898 further receives an identification authentication message 899 for determining as a reference when determining switching between the first control state and the second control state.

In some embodiments, the wireless module and the switch circuit are detachable from the IoT apparatus.

In FIG. 11, a battery 895 supplies power to the wireless module 893 and the switch circuit 898 when there is no power between the line terminal 881 and the neural terminal 882.

In some embodiments, the electric load is a speaker.

In some embodiments, the speaker generates different sound in the first control state and the second state.

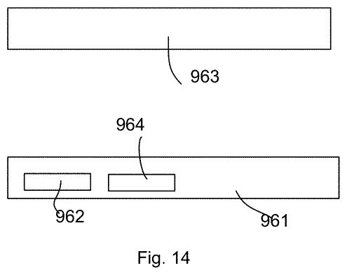

In FIG. 14, the IoT apparatus 961 may also include a detector 962 for detecting a light status of a neighboring light device 963, the switch circuit 964 controls the conductive control system by reference to the detected light status.

In some embodiments, the switch controls the conductive control system to turn on the electric load when the detected light status indicates that the light device is turned off on at a first moment and to turn off the electric load when the detected light status indicates that the light device is turned on at a second moment.

In some embodiments, the control switch controls the conductive switch system to generate a light compensating another light of the neighboring light device to generate a desired color temperature.

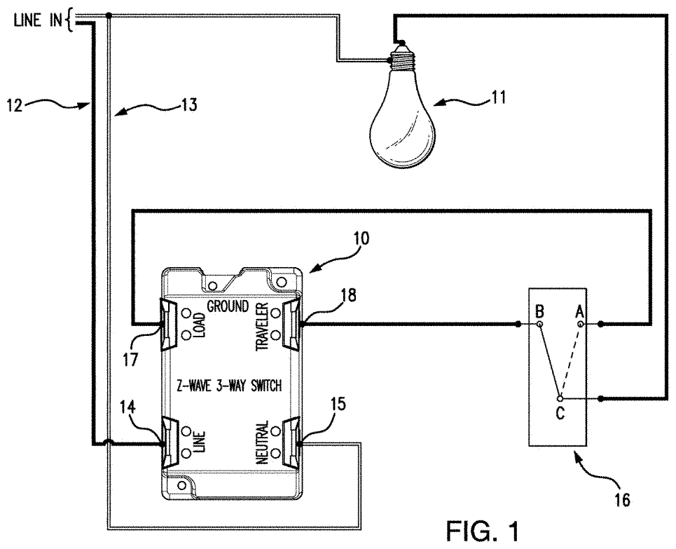

FIGS. 1-3 illustrate how the Z-wave switch of the present invention 10 can be connected to a lighting load 11 through one or more multi-way remote switches. The exemplary circuit shown in FIG. 1 comprises an AC hot line 12, an AC neutral line 13, which are respectively connected to the line terminal 14 and the neutral terminal 15 of the Z-wave switch 10. The Z-wave switch 10, in turn, is connected to the three-way remote switch 16 through load terminal 17 of the Z-wave switch 10, which connects to the first remote terminal “A” of the remote switch 16, and through the traveler terminal 18 of the Z-wave switch 10, which connects to the second remote terminal “B” of the remote switch 16. The common terminal “C” of the remote switch 16 is connected to the lighting load 11.

It should be noted that the Z-wave switch 10 is connected in parallel with the remote switch 16 and the load 11, so that the Z-wave switch 10 continues to draw AC power from the AC hot line 12 regardless of the status of the remote switch 16 or the load 11.

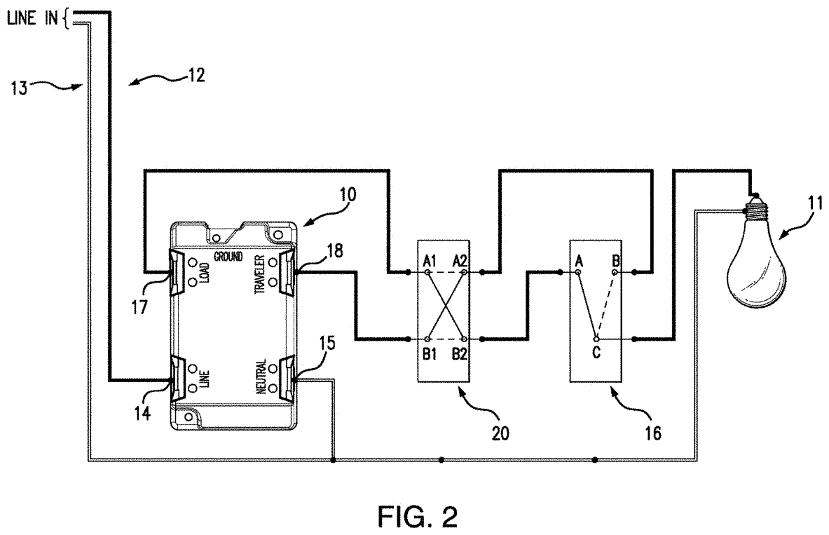

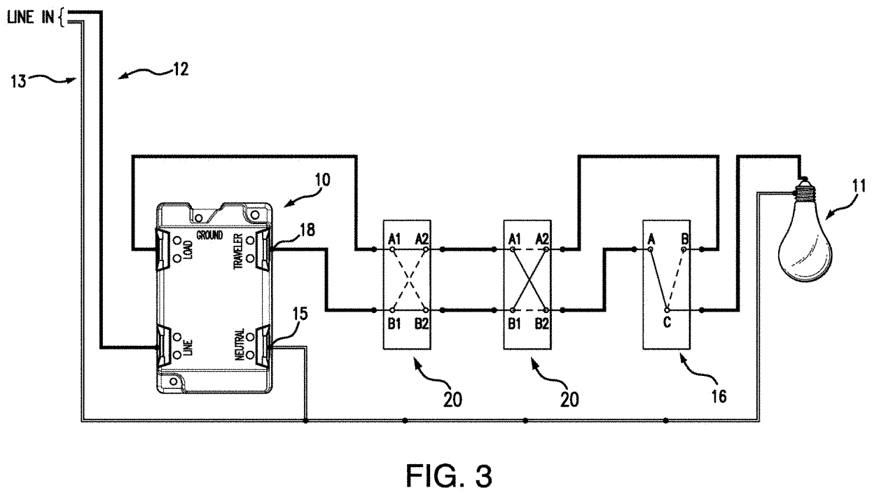

FIGS. 2-3 illustrate how the Z-wave switch 10 can be connected to the three-way remote switch 16 through one or more four-way intermediate switches 20.

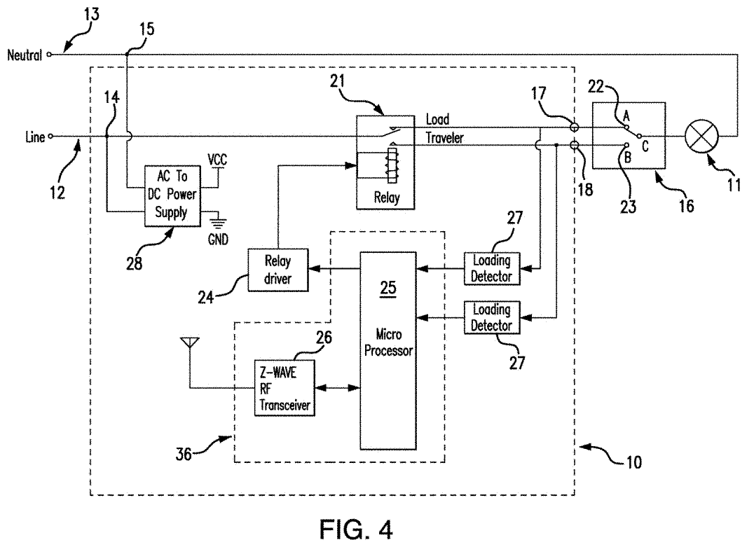

An exemplary on/off version of the Z-wave switch 10, without dimming, is depicted in FIG. 4. The Z-wave switch 10 is connecting through the AC line terminal 14, the neutral terminal 15, the load terminal 17, and the traveler terminal 18. An electromagnetic relay 21 operates to switch the AC line voltage between the load terminal 14, which is connected to the first remote terminal 22 of the remote switch 16, and the traveler terminal 18, which is connected to the second remote terminal 23 of the remote switch 16.

The relay 21 is controlled by a relay driver 24 based on signals sent to the relay driver 24 from the microprocessor switch controller 25. The switch controller 25, in turn, receives control commands from the Z-wave transceiver 26, based on remote RF control commands received by the Z-wave transceiver 26. The switch controller 25 also receives a load current detection signal from one or more current sensing elements 27, which operate to detect a load current flowing through the remote switch 16 to the electrical load 11.

The switch controller 25 operates to switch the control state of the relay 21 from the first control state, in which the line terminal 14 is electrically connected to the load terminal 17, as depicted in FIG. 1, to the second control state, in which the line terminal 14 is electrically connected to the traveler terminal 18, or conversely from the second control state to the first control state. The switch controller 25 electrically communicates the current control state of the relay 21 and the current status of the load current to the Z-wave transceiver 26, which is operable to transmit RF status messages incorporating this information to a remote user.

The switch controller 25 and the Z-wave transceiver 26 are powered by DC (VCC) converted from the line AC by a power supply 28. Since the power supply 28 is connected in parallel between the AC hot line 12 and the AC neutral line 13, it continues to supply DC power to the switch controller 25 and Z-wave transceiver 26 even when the remote switch 16 is in transition or an open circuit develops in the load 11.

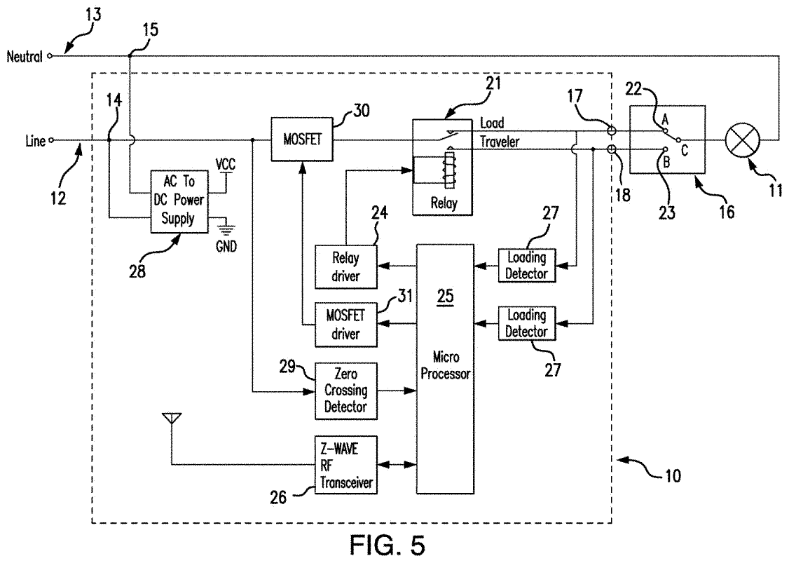

Referring now to FIG. 5, an exemplary dimmer version of the Z-wave switch 10 is shown. The dimmer switch 10 comprises, in addition to the components described above for the on/off version, a zero-crossing detector 29 and a MOSFET (metal-oxide-semiconductor field-effect transistor) 30. The zero-crossing detector detects the zero-crossings of the line AC waveform, which are the times when the AC voltage transitions from positive to negative polarity or vice-versa at the beginning of each AC half-cycle. The zero-crossing detector 29 simultaneously transmits zero-crossing signals to the switch controller 25, which transmits phase control signals to the MOSFET 30 through a MOSFET driver circuit 31. In response to the phase control signals, the MOSFET 30 conducts AC power from the line terminal 14 to the relay 21 only during specified phase intervals, relative to the zero-crossings of the AC waveform, thereby enabling the controlled dimming of the lighting load 11.

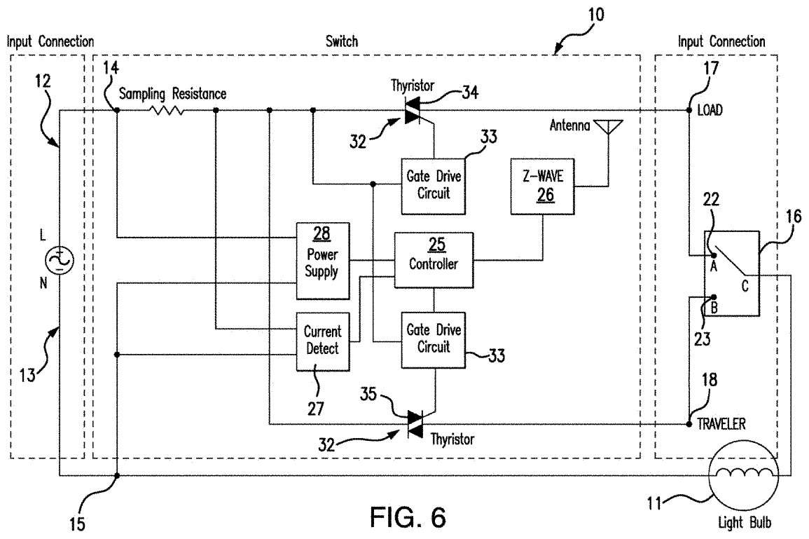

Referring to FIG. 6, another exemplary on/off version of the Z-wave switch 10 is depicted. In this version, the conductive control system consists of a semiconductor switching circuit instead of the relay switching circuit shown in FIGS. 4-5. The semiconductor switching circuit comprises two semiconductor control elements 32, which can be a pair of bidirectional TRIACs (bilateral triode thyristors), as shown in FIG. 6, or a pair of FETs (field-effect transistors) in anti-series connection (as depicted in FIG. 5D of U.S. Pat. No. 8,212,425). In FIG. 6, each of the TRIACs 32 is controlled by the switch controller 25 through a gate drive circuit 33. In the first control state (line terminal 14 connected to load terminal 17), the first TRIAC 34 is conducting and the second TRIAC 35 is not. In the second control state (line terminal 14 connected to traveler terminal 18), the second TRIAC 35 is conducting and the first TRIAC 34 is not.

A dimmer version of the Z-wave switch 10 shown in FIG. 6 can be implemented by adding the zero-crossing detector 29 depicted in FIG. 5 and programming the switch controller 25 to switch the conducting TRIAC 32 to non-conducting during a designated portion of the AC cycle, thereby producing a diminished AC current and enabling controlled dimming of the lighting load 11.

There is an alternative way to achieve the switch function and related circuit.

The embodiments above use current-sensing element. In the alternative solutions explained below, a voltage sensor circuit is used, instead of the current-sensing element.

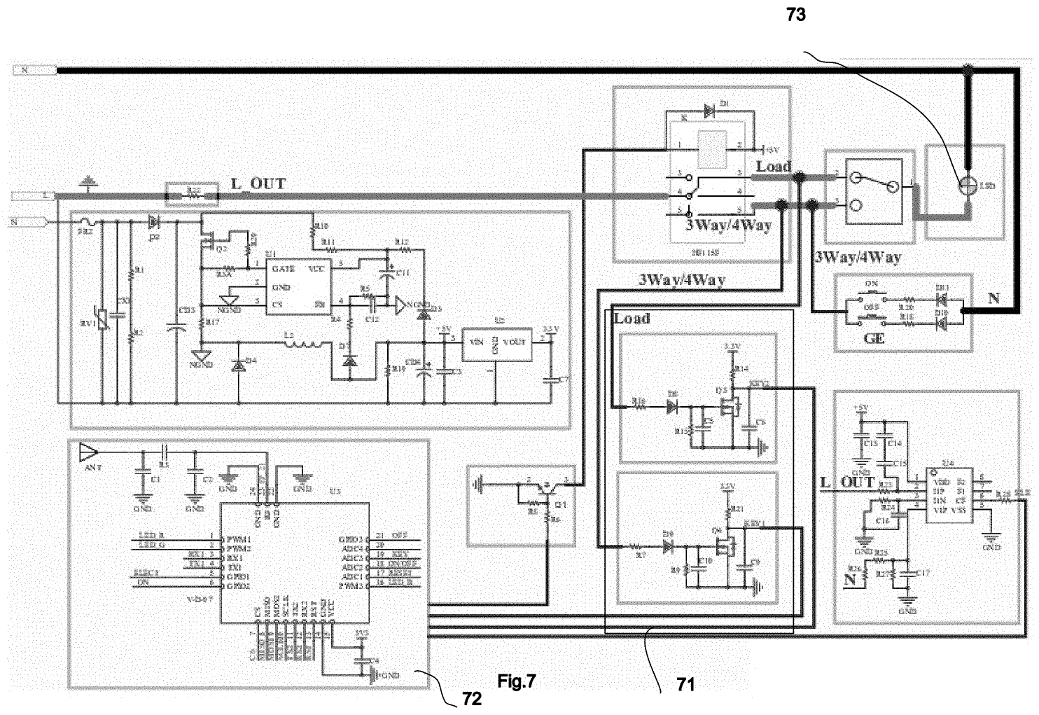

In the circuit diagram of FIG. 7, the switch circuit 71, coupled to a wireless module 72 for receiving a remote control command and for controlling a LED device 73, only detects voltage, instead of detecting whether there is a loading current flowing the switch circuit 71.

In fact, the design illustrated in FIG. 7, the switch circuit 71 also has a signal once the voltage is higher than a threshold even there is no loading current passing through. On the other hand, even there is a loading current, if the voltage is not higher than a threshold, the switch circuit 71 does not have a signal.

In addition, the wireless module 72 may be implemented for other communication protocols, instead of Z-wave.

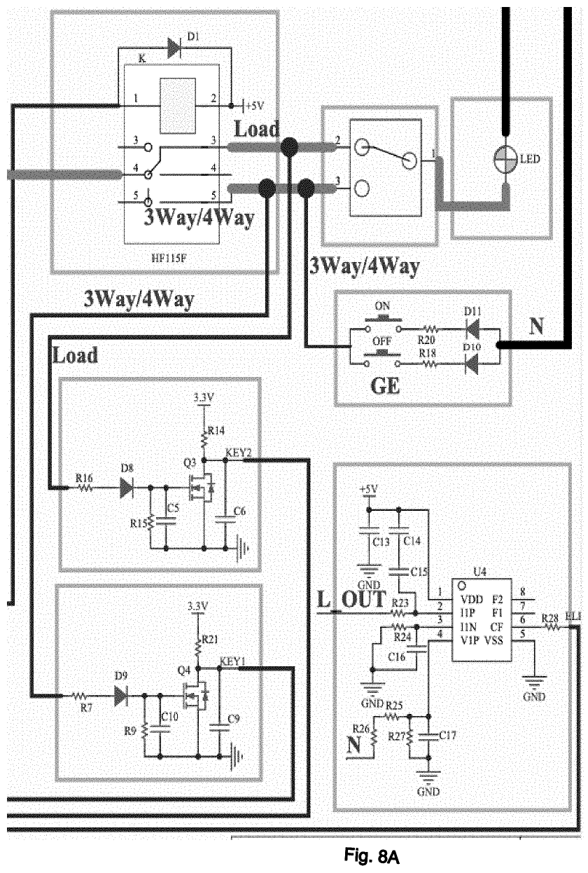

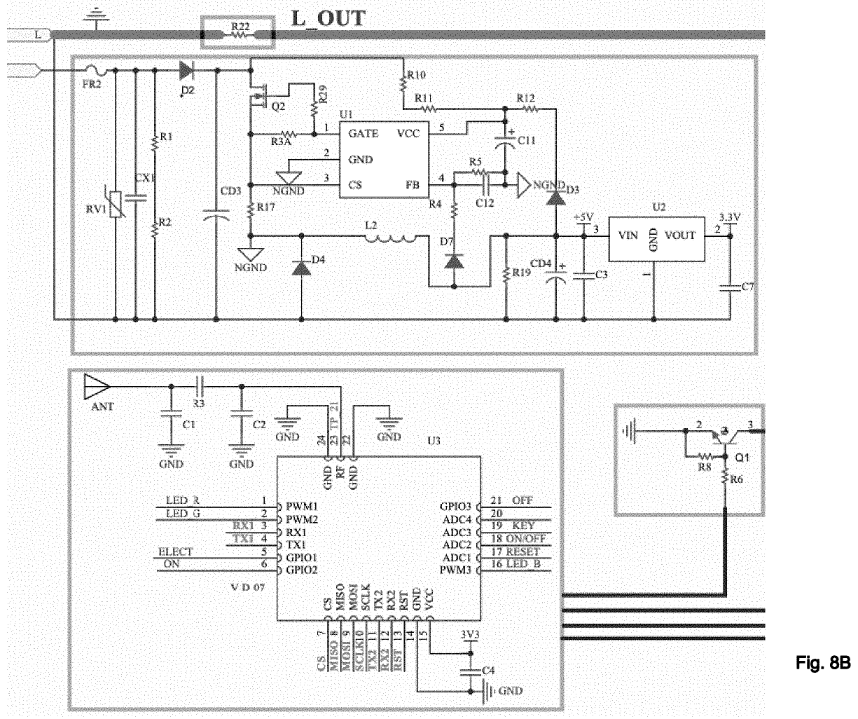

FIG. 8A and FIG. 8B illustrates enlarged portions of FIG. 7.

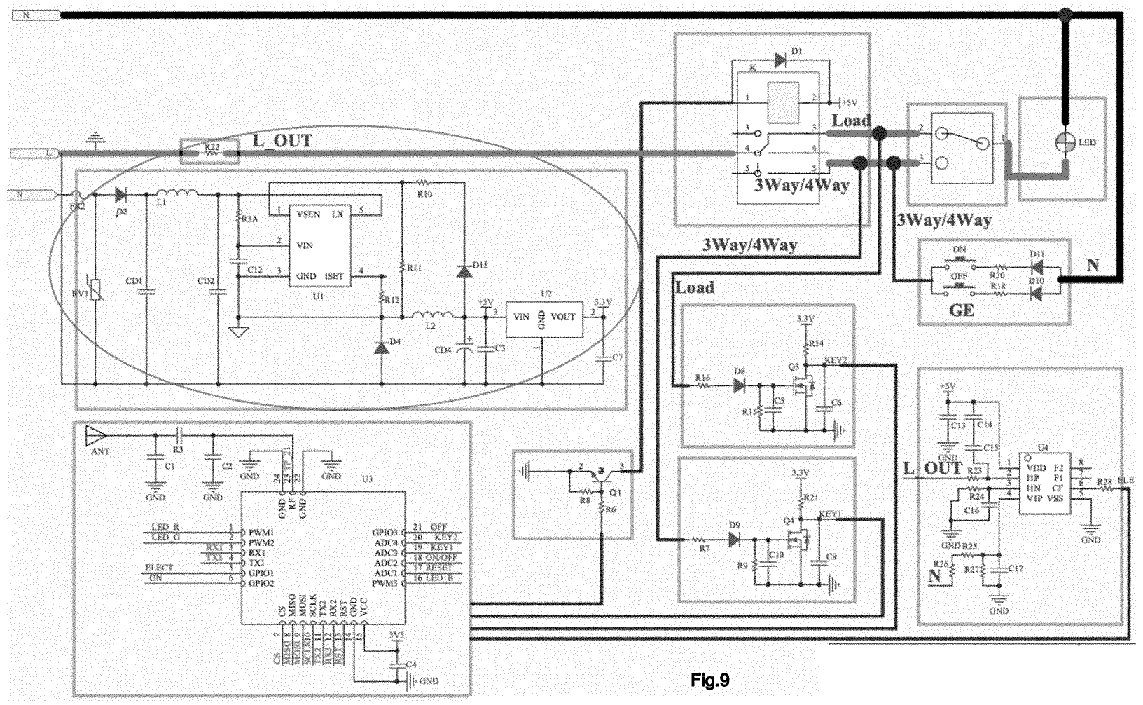

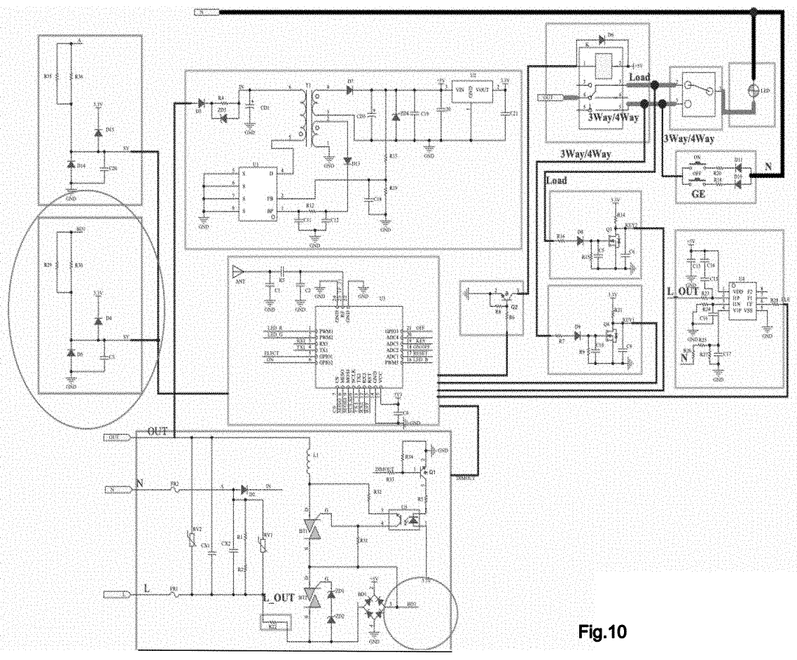

FIG. 9 and FIG. 10 illustrate another two embodiments showing alternative designs, which are independent inventions compared with above mentioned embodiments. Persons skilled in the art would realize how to implement the design by reference to the circuit diagrams. There are some integrated chips illustrated in the drawings and may be replaced with compatible alternative equivalent devices.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings.

The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

1. An IoT apparatus, comprising:
an electric load;
a remote switch, the remote switch having a first remote terminal, a second remote terminal and a common terminal, the common terminal being connected to the electric load, wherein the remote switch has a first position in which the common terminal is electrically connected to the first remote terminal and has a second position in which the common terminal is electrically connected to the second remote terminal;
a line terminal for electrically connecting to an AC hot line;
a neutral terminal for electrically connecting to an AC neutral line;
a load terminal;
a traveler terminal;
a conductive control system, comprising a relay switching circuit, wherein the conductive control system has two control states with a first control state and a second control state, wherein the line terminal is electrically connected to the load terminal in the first control state, and the line terminal is electrically connected to the traveler terminal in the second control state, and wherein the relay switching circuit is switchable between the two control states, the relay switching circuit electrically connects the line terminal to the load terminal and electrically disconnects the line terminal from the traveler terminal in the first control state, and relay switching circuit electrically connects the line terminal to the traveler terminal and electrically disconnects the line terminal from the load terminal in the second control state;
a wireless module for receiving a control command;
a voltage detector connected to the line terminal and the neutral terminal for detecting a voltage instead of a loading current; and
a switch circuit for controlling the conductive control system to switch between the first control state and the second control state, wherein the switch circuit is operable in response to the control command of the wireless module and the detected voltage of the voltage detector.

2. The IoT apparatus of claim 1, wherein the remote switch is a three-way switch.

3. The IoT apparatus of claim 1, wherein the relay switching circuit is an electromagnetic relay switch.

4. The IoT apparatus of claim 1, wherein the switch circuit controls the conductive control system to switch between the first control sate and the second control state even if there is no load current flowing.

5. The IoT apparatus of claim 1, wherein the electric load is a LED module.

6. The IoT apparatus of claim 5, wherein the electric load is controlled by the conductive control system to change a luminance level.

7. The IoT apparatus of claim 5, wherein the LED module has multiple types of LED chips and the conductive control system controls the LED chips to emit a mixed color.

8. The IoT apparatus of claim 5, wherein the LED module has multiple types of LED chips and the conductive control system controls the LED chips to emit a mixed color temperature.

9. The IoT apparatus of claim 1, further comprising a wall switch control detector electrically connected to a wall switch for receiving a wall switch operation, the wall switch operation being translated by the wall switch control detector for combining the wall switch operation with the control command of the wireless module.

10. The IoT apparatus of claim 1, further comprising a power supply circuit connected to the line terminal and the neutral terminal for converting an alternating current to a direct current supplying to the wireless module and the switch circuit.

11. The IoT apparatus of claim 1, wherein the switch circuit further receives an identification authentication message for determining as a reference when determining switching between the first control state and the second control state.

12. The IoT apparatus of claim 1, wherein the wireless module and the switch circuit are detachable from the IoT apparatus.

13. The IoT apparatus of claim 1, where a battery supplies power to the wireless module and the switch circuit when there is no power between the line terminal and the neural terminal.

14. The IoT apparatus of claim 1, wherein the electric load is a speaker.

15. The IoT apparatus of claim 14, wherein the speaker generates different sound in the first control state and the second state.

16. The IoT apparatus of claim 1, further comprising a detector for detecting a light status of a neighboring light device, the switch circuit controls the conductive control system by reference to the detected light status.

17. The IoT apparatus of claim 16, wherein the switch controls the conductive control system to turn on the electric load when the detected light status indicates that the light device is turned off on at a first moment and to turn off the electric load when the detected light status indicates that the light device is turned on at a second moment.

18. The IoT apparatus of claim 16, wherein the control switch controls the conductive switch system to generate a light compensating another light of the neighboring light device to generate a desired color temperature.
